(19) United States
(12) Patent Application Publication
(10) Pub. No.: US 2018/0174602 A1
(43) Pub. Date: Jun. 21, 2018

(54) SPEECH DETECTION METHOD AND APPARATUS

(71) Applicant: Sengled Co., Ltd., Shanghai (CN)

(72) Inventors: Xingming DENG, Shanghai (CN); Hui WU, Shanghai (CN); Jinxiang SHEN, Shanghai (CN)

(21) Appl. No.: 15/737,669

(22) PCT Filed: Dec. 15, 2016
(86) PCT No.: PCT/CN2016/110052

§ 371 Date: Dec. 18, 2017

(30) Foreign Application Priority Data
Dec. 30, 2015 (CN) 201511020926.8

(51) Int. Cl. G10L 25/78; G10L 25/03

(52) U.S. Cl. CPC G10L 25/78; G10L 25/03

(57) ABSTRACT

In accordance with various embodiments of the disclosed subject matter, a speech detection method and a related apparatus are provided. The speech detection method includes the steps of switching a speech acquisition system from a non-trigger mode into a trigger mode according to a the first preset condition, recording a trigger mode operating reference time starting from zero, and setting a non-trigger mode operating reference time to zero; acquiring speech signals by using the speech acquisition system in the trigger mode to obtain first pulse-code modulation data; extracting the first pulse-code modulation data during the trigger mode operating reference time according to a second preset condition; and matching the first pulse-code modulation data during the trigger mode operating reference time with a speech model to obtain speech data.

### CROSS-REFERENCES TO RELATED APPLICATIONS

This PCT patent application claims priority of Chinese Patent Application No. 201511020926.8, filed on Dec. 30, 2015, the entire content of which is incorporated by reference herein.

### TECHNICAL FIELD

The disclosed subject matter generally relates to the field of speech detection technology and, more particularly, relates to a speech detection method and a related apparatus.

### BACKGROUND

With the continuous development of smart home technology, speech control is widely used in daily life. For example, a user can remotely control various household electrical appliances by using the speech control technology. An accurate speech detection is an important prerequisite for an effective speech control.

Currently, the speech detection is generally realized by using hardware such as a digital signal processing (DSP) chip. The cost of hardware for speech detection is generally high, and the power consumption of a speech control hardware system is relatively large.

Accordingly, it is desirable to provide a speech detection method and a related apparatus.

### BRIEF SUMMARY

In accordance with some embodiments of the disclosed subject matter, a speech detection method and a related apparatus are provided.

An aspect of the present disclosure provides a speech detection method. The method includes switching a speech acquisition system from a non-trigger mode into a trigger mode according to a the first preset condition, recording a trigger mode operating reference time starting from zero, and setting a non-trigger mode operating reference time to zero; acquiring speech signals by using the speech acquisition system in the trigger mode to obtain first pulse-code modulation data; extracting the first pulse-code modulation data during the trigger mode operating reference time according to a second preset condition; and matching the first pulse-code modulation data during the trigger mode operating reference time with a speech model to obtain speech data.

Optionally, the first preset condition is determined based on the non-trigger mode operating reference time and second pulse-code modulation data during the non-trigger mode operating reference time; and the second preset condition is determined based on the trigger mode operating reference time, the first pulse-code modulation data within a preset time, and the second pulse-code modulation data.

Optionally, before switching the speech acquisition system from the non-trigger mode into the trigger mode, the method includes recording the non-trigger mode operating reference time starting from zero; and acquiring speech signals by using the speech acquisition system in the non-trigger mode to obtain the second pulse-code modulation data.

Optionally, after extracting the first pulse-code modulation data during the trigger mode operating reference time, performing a Fourier-transformation to the first pulse-code modulation data to calculate corresponding decibel values of the first pulse-code modulation data; and after extracting the second pulse-code modulation data during the non-trigger mode operating reference time, performing a Fourier-transformation to the second pulse-code modulation data to calculate corresponding decibel values of the second pulse-code modulation data.

Optionally, the first preset condition includes a first sub-condition that the recorded non-trigger mode operating reference time is equal to or longer than a first threshold value; and a second sub-condition that a difference between a decibel value of the most recently acquired second pulse-code modulation data and an average decibel value of the second pulse-code modulation data during the entire non-trigger mode operating reference time is equal to or longer than the first preset value. When the first sub-condition and the second sub-condition are both satisfied, the first preset condition is satisfied.

Optionally, the first threshold value is a minimum speech abrupt detection time; and the first preset value is in a range from 8 dB to 12 dB. The second preset condition includes a third sub-condition that the trigger mode operating reference time is equal to or longer than the second threshold value; a fourth sub-condition that the trigger mode operating reference time is less than a third threshold value; and a fifth sub-condition that a difference between an average decibel value of the first pulse-code modulation data within a preset time and an average decibel value of the second pulse-code modulation data in the non-trigger mode is less than a second preset value. When the third sub-condition, the fourth sub-condition, and the fifth sub-condition are all satisfied, the second preset condition is satisfied.

Optionally, the second threshold value is an effective speech input start analysis time; the third threshold value is an effective speech input analysis time-out time; the preset time is in a range from 1 second to 5 seconds; and the second preset value is around from 1 dB to 3 dB.

Optionally, in response to determining that the trigger mode operating reference time is longer than the third threshold value, switching the speech acquisition system from the trigger mode into the non-trigger mode, and recording the non-trigger mode operating reference time starting from zero, and set the trigger mode operating reference time to zero.

Optionally, in response to determining that the first pulse-code modulation data during the trigger mode operating reference time has been extracted, switching the speech acquisition system from the trigger mode into the non-trigger mode, and recording the non-trigger mode operating reference time starting from zero, and set the trigger mode operating reference time to zero.

Another aspect of the present disclosure provides a non-transitory computer readable memory comprising a computer readable program stored thereon, wherein, when being executed. The computer readable program causes a computer to implement a speech detection method. The method includes switching a speech acquisition system from a non-trigger mode into a trigger mode according to a the first preset condition, and in the meantime recording a trigger mode operating reference time starting from zero, and setting a non-trigger mode operating reference time to zero; acquiring speech signals by using the speech acquisition system in the trigger mode to obtain first pulse-code modulation data; extracting the first pulse-code modulation data during the trigger mode operating reference time according to a second preset condition; and matching the first pulse-code modulation data during the trigger mode operating reference time with a speech model to obtain speech data.

Optionally, the first preset condition is determined based on the non-trigger mode operating reference time and second pulse-code modulation data during the non-trigger mode operating reference time; and the second preset condition is determined based on the trigger mode operating reference time, the first pulse-code modulation data within a preset time, and the second pulse-code modulation data.

Optionally, before switching the speech acquisition system from the non-trigger mode into the trigger mode, the method further includes recording the non-trigger mode operating reference time starting from zero; and acquiring speech signals by using the speech acquisition system in the non-trigger mode to obtain the second pulse-code modulation data.

Optionally, the method further includes after extracting the first pulse-code modulation data during the trigger mode operating reference time, performing a Fourier-transformation to the first pulse-code modulation data to calculate corresponding decibel values of the first pulse-code modulation data; and after extracting the second pulse-code modulation data during the non-trigger mode operating reference time, performing a Fourier-transformation to the second pulse-code modulation data to calculate corresponding decibel values of the second pulse-code modulation data.

Optionally, the first preset condition includes a first sub-condition that the recorded non-trigger mode operating reference time is equal to or longer than a first threshold value; and a second sub-condition that a difference between a decibel value of the most recently acquired second pulse-code modulation data and an average decibel value of the second pulse-code modulation data during the entire non-trigger mode operating reference time is equal to or longer than the first preset value. When the first sub-condition and the second sub-condition are both satisfied, the first preset condition is satisfied.

Optionally, the first threshold value is a minimum speech abrupt detection time; and the first preset value is in a range from 8 dB to 12 dB.

Optionally, the second preset condition includes a third sub-condition that the trigger mode operating reference time is equal to or longer than the second threshold value; a fourth sub-condition that the trigger mode operating reference time is less than a third threshold value; and a fifth sub-condition that a difference between an average decibel value of the first pulse-code modulation data within a preset time and an average decibel value of the second pulse-code modulation data in the non-trigger mode is less than a second preset value. When the third sub-condition, the fourth sub-condition, and the fifth sub-condition are all satisfied, the second preset condition is satisfied.

Optionally, the second threshold value is an effective speech input start analysis time; the third threshold value is an effective speech input analysis time-out time; the preset time is in a range from 1 second to 5 seconds; and the second preset value is around from 1 dB to 3 dB.

Optionally, in response to determining that the trigger mode operating reference time is longer than the third threshold value, switching the speech acquisition system from the trigger mode into the non-trigger mode, and recording the non-trigger mode operating reference time starting from zero, and set the trigger mode operating reference time to zero.

Optionally, in response to determining that the first pulse-code modulation data during the trigger mode operating reference time has been extracted, switching the speech acquisition system from the trigger mode into the non-trigger mode, and recording the non-trigger mode operating reference time starting from zero, and set the trigger mode operating reference time to zero.

Other aspects of the present disclosure can be understood by those skilled in the art in light of the description, the claims, and the drawings of the present disclosure.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements. It should be noted that the following drawings are merely examples for illustrative purposes according to various disclosed embodiments and are not intended to limit the scope of the present disclosure.

FIG. 1 is a schematic diagram of an exemplary speech detection method in accordance with some embodiments of the disclosed subject matter;

FIG. 2 is a schematic flowchart of an exemplary speech detection method in accordance with some embodiments of the disclosed subject matter; and

FIG. 3 is a schematic structural diagram of an exemplary speech detection apparatus in accordance with some embodiments of the disclosed subject matter.

### DETAILED DESCRIPTION

For those skilled in the art to better understand the technical solution of the disclosed subject matter, reference will now be made in detail to exemplary embodiments of the disclosed subject matter, which are illustrated in the accompanying drawings. Wherever possible, the same reference numbers will be used throughout the drawings to refer to the same or like parts.

In accordance with various embodiments, the disclosed subject matter provides a speech detection method and a related apparatus.

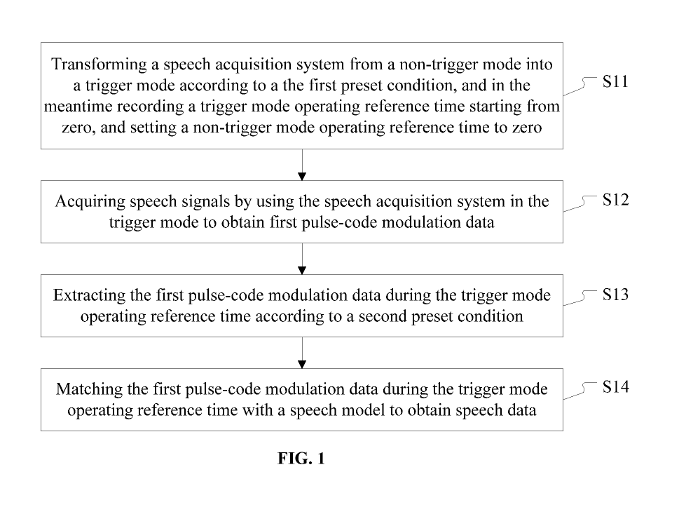

FIG. 1 is a schematic diagram of an exemplary speech detection method in accordance with some embodiments of the disclosed subject matter. As illustrated, the disclosed speech detection method can include the following steps.

At step S11, a speech acquisition system can be enter a trigger mode from a non-trigger mode according to a the first preset condition. Meanwhile, a trigger mode operating reference time T1 can be recorded starting from zero, and a non-trigger mode operating reference time T2 can be set to zero.

At step S12, speech signals can be acquired by the speech acquisition system in the trigger mode to obtain first pulse-code modulation (PCM) data.

At step S13, the first PCM data during the trigger mode operating reference time T1 can be extracted according to a second preset condition.

At step S14, the first PCM data during the trigger mode operating reference time T1 can be matched with a speech model to obtain speech data.

Specifically, in some embodiments, the first preset condition can be determined based on the non-trigger mode operating reference time T2 and second PCM data during the non-trigger mode operating reference time T2. The second preset condition can be determined based on the trigger mode operating reference time T1, the first PCM data within a preset time, and the second PCM data.

Further, before step S11, the non-trigger mode operating reference time T2 can be recorded starting from zero, and speech signals can be acquired by the speech acquisition system in the non-trigger mode to obtain the second PCM data.

In some embodiments, a first threshold value can be set as a time limitation of the non-trigger mode operating reference time T2. When determining if the speech acquisition system enters the trigger mode from the non-trigger mode according to the first preset condition, the recorded non-trigger mode operating reference time T2 can be compared with the first threshold value.

If the recorded non-trigger mode operating reference time T2 is less than the first threshold value, it can be determined that the speech acquisition system is still in the non-trigger mode, and the speech signals can be continually acquired by the speech acquisition system in the non-trigger mode to obtain the second PCM data.

If the recorded non-trigger mode operating reference time T2 is reached the first threshold value, which means when T2 being equal to or longer than the first threshold value, it can be further determined whether or not there is an effective speech input.

In some embodiments, whether or not there is an effective speech input can be determined based on a difference between a decibel value of the most recently acquired second PCM data and an average decibel value of the second PCM data during the entire non-trigger mode operating reference time T2. In particular, when the difference between the decibel value of the most recently acquired second PCM data and the average decibel value of the second PCM data during the entire non-trigger mode operating reference time T2 is longer than or equal to the first preset value, it can be determined that there is an effective speech input.

That is, the first preset condition can includes two sub-conditions. The first sub-condition is that the recorded non-trigger mode operating reference time T2 is equal to or longer than the first threshold value. The second sub-condition is that the difference between the decibel value of the most recently acquired second PCM data and the average decibel value of the second PCM data during the entire non-trigger mode operating reference time T2 is equal to or longer than the first preset value.

When the first preset condition is satisfied, that means that the first sub-condition and the second sub-condition are satisfied simultaneously, it can be determined that the speech acquisition system can enter the trigger mode from the non-trigger mode. And in the meantime, the trigger mode operating reference time T1 can be recorded starting from zero, and the non-trigger mode operating reference time T2 can be set to zero.

Contrarily, when the first sub-condition and the second sub-condition are not satisfied simultaneously, the first preset condition is not satisfied. For example, the recorded non-trigger mode operating reference time T2 is less than the first threshold value, or when recorded non-trigger mode operating reference time T2 is equal to or longer than the first threshold value, but the difference between the decibel value of the most recently acquired second PCM data and the average decibel value of the second PCM data during the entire non-trigger mode operating reference time T2 is less than the first preset value. When the first preset condition is not satisfied, it can be determined that the speech acquisition system can be still in the non-trigger mode.

In some embodiments, a second threshold value and a third threshold value can be set as time limitations of the trigger mode operating reference time T1. The second condition can include a third sub-condition and a fourth sub-condition. The third sub-condition is that the trigger mode operating reference time T1 is equal to or longer than the second threshold value.

The fourth sub-condition is that the trigger mode operating reference time T1 is less than the third threshold value.

When extracting the first PCM data during the trigger mode operating reference time T1 based on the second preset condition, if the trigger mode operating reference time T1 is less than the second threshold value, it can be determined that the speech acquisition system is still in the trigger mode, and the speech signals can be continually acquired by the speech acquisition system in the trigger mode to obtain the first PCM data.

If the second condition is satisfied, which means the trigger mode operating reference time T1 is equal to or longer than the second threshold value, and less than the third threshold value, it can be further determined whether the effective speech input is ended.

In some embodiments, the determination of whether the effective speech input is ended can be made based on a fifth sub-condition. Specifically, the fifth sub-condition is that a difference between an average decibel value of the first PCM data within a preset time and an average decibel value of the second PCM data in the non-trigger mode is less than a second preset value. When the fifth condition is satisfied, it can be determined that the effective speech input is ended, and the first PCM data within the trigger mode operating reference time T1 can be extracted.

That is, when the third sub-condition, the fourth sub-condition, and the fifth sub-condition are satisfied simultaneously, the second preset condition can be satisfied. Once the second preset condition is satisfied, the first PCM data within the trigger mode operating reference time T1 can be extracted.

Further, after extracting the first PCM data, it can be determined that the speech acquisition system can switch to the non-trigger mode from the trigger mode. And in the meantime, the non-trigger mode operating reference time T2 can be recorded starting from zero, and the trigger mode operating reference time T1 can be set to zero.

Conversely, the trigger mode operating reference time T1 is longer than the third threshold value, it can also be determined that the speech acquisition system can switch to the non-trigger mode from the trigger mode. And in the meantime, the non-trigger mode operating reference time T2 can be recorded starting from zero, and the trigger mode operating reference time T1 can be set to zero.

It should be noted that, in order to obtain the decibel values of the respective PCM data, after obtaining the first PCM data and the second PCM data, a Fourier-transformation can be performed to first PCM data and the second PCM data respectively to calculate the corresponding decibel values of the first PCM data and the second PCM data.

In some embodiments, the first threshold value can be set as a minimum speech abrupt detection time, the second threshold value can be set as an effective speech input start analysis time, and the third threshold value can be set as an effective speech input analysis time-out time.

It should be noted that, in a specific implementation process, the preset time, the first preset value, and the second preset value may be determined in accordance with an actual speech detection environment, a sensitivity of the speech collection device, etc.

The disclosed speech detection method can perform speech acquisition and speech extraction operation according to a preset determination condition. That is, a software algorithm can be used to determine a speech data input trigger. When a speech data input trigger is detected, the software algorithm can also determine an end of the speech data input. The disclosed method can replace the traditional hardware DSP chip in a form of software to realize the speech detection. Without reducing the detection performance, the disclosed method can effectively reduce the product cost of hardware, and certainly reduce the system power consumption.

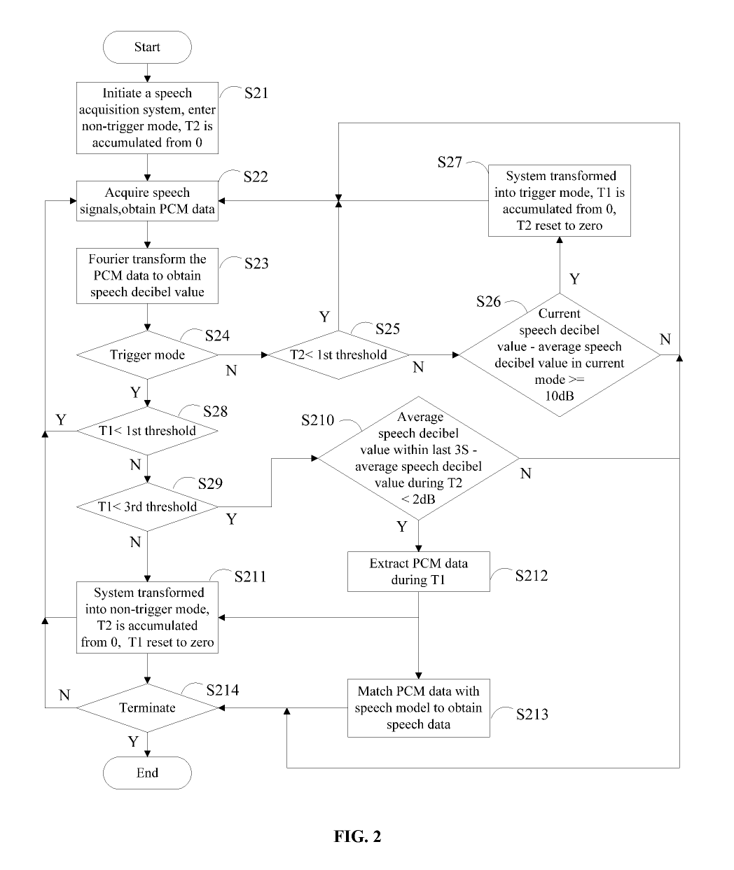

Referring to FIG. 2, a schematic flowchart of an exemplary speech detection method is shown in accordance with some embodiments of the disclosed subject matter. As illustrated, the speech detection method can include the following steps.

At step S21, a speech acquisition system can be initiated to enter a non-trigger mode, and a non-trigger mode operating reference time T2 can be accumulated starting from zero.

At step S22, speech signals can be acquired by the speech acquisition system to obtain corresponding pulse-code modulation (PCM) data.

At step S23, a Fourier transformation can be performed to the PCM data acquired in S22 to obtain a current speech decibel value.

At step S24, it is can be determined whether the speech acquisition system is currently in the trigger mode. If a result of the determination is true (“Y” of S24), step S28 can be then executed. If a result of the determination is false (“N” of S24), step S25 can be then executed.

At step S25, it is can be determined whether the non-trigger mode operating reference time T2 is less than a first threshold value. If a result of the determination is true (“Y” of S25), steps S22-S24 can be then executed. If a result of the determination is false (“N” of S25), step S26 can be then executed.

At step S26, it is can be determined whether a difference between a most recently obtained speech decibel value and an average speech decibel value in a current mode is equal to or larger than 10 dB. If a result of the determination is true (“Y” of S26), step S7 can be then executed. If a result of the determination is false (“N” of S26), steps S22-S24 can be then executed.

At step S27, the speech acquisition system can be switched from the non-trigger mode into a trigger mode. In the meantime, a trigger mode operating reference time T1 can be accumulated starting from zero, and the non-trigger mode operating reference time T2 can be reset to zero.

At step S28, it can be determined whether the trigger mode operating reference time T1 is less than a second threshold value. If a result of the determination is true (“Y” of S28), steps S22-S24 can be then executed. If a result of the determination is false (“N” of S28), step S29 can be then executed.

At step S29, it can be determined whether the trigger mode operating reference time T1 is less than a third threshold value. If a result of the determination is true (“Y” of S29), step S210 can be then executed. If a result of the determination is false (“N” of S29), step S211 can be then executed.

At step S210, it can be determined whether a difference between an average speech decibel value within last three seconds and an average speech decibel value during the non-triggering mode operating reference time T2 is less than 2 dB. If a result of the determination is true (“Y” of S210), steps S211-S213 can be then executed. If a result of the determination is false (“N” of S210), steps S22-S24 can be then executed.

At step S211, the speech acquisition system can be switched from the trigger mode into the non-trigger mode. In the meantime, the non-trigger mode operating reference time T2 can be accumulated starting from zero, and the trigger mode operating reference time T1 can be reset to zero.

At step S212, the PCM data during the trigger mode operating reference time T1 can be extracted.

At step S213, the PCM data extracted in S212 can be matched with a speech model to obtain speech data.

In some embodiments, a step S214 can be executed after the step S211 and/or step 213. At step S214, it can be determined that whether a terminate instruction is received. If a result of the determination is true (“Y” of S214), the speech detection process can be terminated. If a result of the determination is false (“N” of S214), steps S22-S24 can be then executed.

It should be noted that, the flowchart described above in connection with FIG. 2 is an example to further explain the disclosed speech detection method illustrated in FIG. 1, and should not limit the scope of the disclosed subject matter.

Another aspect of the disclosed subject matter provides a speech detection apparatus to implement the disclosed speech detection method described above in connection with FIGS. 1 and 2. The speech detection apparatus can be integrated in a control terminal, and the speech detection apparatus can be realized by a software method.

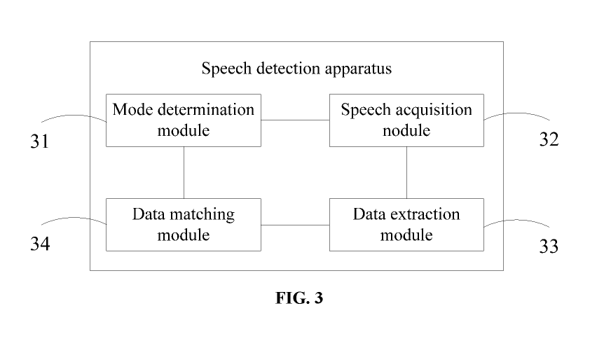

Referring to FIG. 3, a schematic structural diagram of an exemplary speech detection apparatus is shown in accordance with some embodiments of the disclosed subject matter. As illustrated, the speech detection apparatus can include a mode determination module 31, a speech acquisition nodule 32, a data extraction module 33, and a data matching module 34.

The mode determination module 31 can be configured for switching a speech acquisition system from a non-trigger mode into a trigger mode according to a the first preset condition, and in the meantime recording a trigger mode operating reference time T1 starting from zero, and setting a non-trigger mode operating reference time T2 to zero.

The speech acquisition nodule 32 can be configured for acquiring speech signals by using the speech acquisition system in the trigger mode to obtain first pulse-code modulation (PCM) data.

The data extraction module 33 can be configured for extracting the first PCM data during the trigger mode operating reference time T1 according to a second preset condition.

The data matching module 34 can be configured for matching the first PCM data during the trigger mode operating reference time T1 with a speech model to obtain speech data.

In some embodiments, the mode determination module 31 can be further configured for recording the non-trigger mode operating reference time T2 starting from zero. And the speech acquisition nodule 32 can be further configured for acquiring speech signals by using the speech acquisition system in the non-trigger mode to obtain the second PCM data.

In some implementations, the speech acquisition nodule 32 can be further configured for performing a Fourier-transformation to the first PCM data to calculate the corresponding decibel values of the first PCM data. In some implementations, the speech acquisition nodule 32 can be further configured for performing a Fourier-transformation to the second PCM data to calculate the corresponding decibel values of the second PCM data.

Specifically, the first preset condition can includes two sub-conditions. The first sub-condition is that the recorded non-trigger mode operating reference time T2 is equal to or longer than the first threshold value. The second sub-condition is that the difference between the decibel value of the most recently acquired second PCM data and the average decibel value of the second PCM data during the entire non-trigger mode operating reference time T2 is equal to or longer than the first preset value.

Therefore, the mode determination module 31 can be configured for determining whether the first preset condition is satisfied. That is, when the first sub-condition and the second sub-condition are satisfied simultaneously, the mode determination module 31 can switch the speech acquisition system from the non-trigger mode into the trigger mode.

In some embodiments, the first threshold value can be set as a minimum speech abrupt detection time.

Specifically, the second preset condition can includes three sub-conditions. The third sub-condition is that the trigger mode operating reference time T1 is equal to or longer than the second threshold value. The fourth sub-condition is that the trigger mode operating reference time T1 is less than the third threshold value. The fifth sub-condition is that a difference between an average decibel value of the first PCM data within a preset time and an average decibel value of the second PCM data in the non-trigger mode is less than a second preset value.

Therefore, the mode determination module 31 can be configured for determining whether the second condition is satisfied. That is, when the third sub-condition, the fourth sub-condition, and the fifth sub-condition are satisfied simultaneously, the mode determination module 31 can extract the first PCM data during the trigger mode operating reference time T1.

In some embodiment, the second threshold value can be set as an effective speech input start analysis time, and the third threshold value can be set as an effective speech input analysis time-out time.

Additionally, in some implementations, the mode determination module 31 can be further configured for determining whether the trigger mode operating reference time T1 is longer than the third threshold value, and determining whether the first PCM data during the trigger mode operating reference time T1 has been extracted. When any one of the above two conditions is satisfied, the mode determination module 31 can switch the speech acquisition system from the trigger mode into the non-trigger mode. And in the meantime, the mode determination module 31 can record the non-trigger mode operating reference time T2 starting from zero, and set the trigger mode operating reference time T1 to zero.

As described above, the disclosed speech detection apparatus can realize the disclosed speech detection method illustrated in FIGS. 1 and 2.

In some embodiments, the speech detection apparatus may include a lighting module. The lighting module may include a light that displays different colors of light when the speech detection apparatus is a trigger mode or a non-trigger mode. For example, the lighting module may show a blue light when the apparatus is in a trigger mode, and show a yellow light when the apparatus is in a non-trigger mode. Further, the lighting module may display a different color (e.g., green) of light when the apparatus recognizes a speech pattern, such as a pattern for an audio command.

In some embodiments, the speech detection apparatus may connect to a smart home controller. The smart home controller may connect to a number of smart appliances, such as smart lights, smart audio systems, a smart refrigerator, etc. A user may speak to the speech detection apparatus. The smart home controller may receive detected voice command from the speech detection apparatus. A voice command may be, for example, “turn on the speaker.” The smart home controller may then turn on the speaker.

In some embodiments, the smart lights in the home may also display light of different colors and different brightness levels, based on the user's command to the speech detection apparatus. For example, if the speech detection apparatus is in a non-trigger mode, the smart lights may be in a dim mode. When the speech detection apparatus enters the trigger mode, the smart lights can be adjusted to a brighter light or light of a different color. When the speech data are obtained (e.g., step S213), the smart lights may adjust its lighting accordingly. For example, if a user issues a command to “turn on the television.” The speech recognition system obtains the speech data of this command; the smart lights may go into a dim mode that is appropriate for television watching. In another example, if a user issues a command to “open the refrigerator.” The speech recognition system obtains the speech data of this command; the smart lights close to the refrigerator may turn into a bright light mode for the user to look inside the refrigerator.

It should be understood by those of ordinary skill in the art that, all or part of the steps of implementing the above-described embodiments may be accomplished by program related hardware. The program may be stored in a computer-readable storage medium. When the program is executed, the steps including the above-described embodiments can be executed. The storage medium can include various kinds of media, such as a ROM, a RAM, a magnetic disk, or an optical disk, on which program codes can be stored.

The descriptions of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, a speech detection method and a related apparatus are provided.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

What is claimed is:

1. A speech detection method, comprising:
switching a speech acquisition system from a non-trigger mode into a trigger mode according to a first preset condition, recording a trigger mode operating reference time starting from zero, and setting a non-trigger mode operating reference time to zero;
acquiring speech signals by using the speech acquisition system in the trigger mode to obtain first pulse-code modulation data;
extracting the first pulse-code modulation data during the trigger mode operating reference time according to a second preset condition; and
matching the first pulse-code modulation data during the trigger mode operating reference time with a speech model to obtain speech data.

2. The speech detection method of claim 1, wherein:
the first preset condition is determined based on the non-trigger mode operating reference time and second pulse-code modulation data during the non-trigger mode operating reference time; and
the second preset condition is determined based on the trigger mode operating reference time, the first pulse-code modulation data within a preset time, and the second pulse-code modulation data.

3. The speech detection method of claim 1, before switching the speech acquisition system from the non-trigger mode into the trigger mode, further comprising:
recording the non-trigger mode operating reference time starting from zero; and
acquiring speech signals by using the speech acquisition system in the non-trigger mode to obtain the second pulse-code modulation data.

4. The speech detection method of claim 1, further comprising:
after extracting the first pulse-code modulation data during the trigger mode operating reference time, performing a Fourier-transformation to the first pulse-code modulation data to calculate corresponding decibel values of the first pulse-code modulation data; and
after extracting the second pulse-code modulation data during the non-trigger mode operating reference time, performing a Fourier-transformation to the second pulse-code modulation data to calculate corresponding decibel values of the second pulse-code modulation data.

5. The speech detection method of claim 2, wherein the first preset condition includes:
a first sub-condition that the recorded non-trigger mode operating reference time is equal to or longer than a first threshold value; and
a second sub-condition that a difference between a decibel value of the most recently acquired second pulse-code modulation data and an average decibel value of the second pulse-code modulation data during the entire non-trigger mode operating reference time is equal to or longer than the first preset value;
wherein when the first sub-condition and the second sub-condition are both satisfied, the first preset condition is satisfied.

6. The speech detection method of claim 5, wherein:
the first threshold value is a minimum speech abrupt detection time; and
the first preset value is in a range from 8 dB to 12 dB.

7. The speech detection method of claim 2, wherein the second preset condition includes:
a third sub-condition that the trigger mode operating reference time is equal to or longer than the second threshold value;
a fourth sub-condition that the trigger mode operating reference time is less than a third threshold value; and
a fifth sub-condition that a difference between an average decibel value of the first pulse-code modulation data within a preset time and an average decibel value of the second pulse-code modulation data in the non-trigger mode is less than a second preset value;
wherein when the third sub-condition, the fourth sub-condition, and the fifth sub-condition are all satisfied, the second preset condition is satisfied.

8. The speech detection method of claim 7, wherein:
the second threshold value is an effective speech input start analysis time;
the third threshold value is an effective speech input analysis time-out time;
the preset time is in a range from 1 seconds to 5 seconds; and
the second preset value is around from 1 dB to 3 dB.

9. The speech detection method of claim 7, further comprising:
in response to determining that the trigger mode operating reference time is longer than the third threshold value, switching the speech acquisition system from the trigger mode into the non-trigger mode, and recording the non-trigger mode operating reference time starting from zero, and set the trigger mode operating reference time to zero.

10. The speech detection method of claim 1, further comprising:
in response to determining that the first pulse-code modulation data during the trigger mode operating reference time has been extracted, switching the speech acquisition system from the trigger mode into the non-trigger mode, and recording the non-trigger mode operating reference time starting from zero, and set the trigger mode operating reference time to zero.

11. A non-transitory computer readable memory comprising a computer readable program stored thereon, wherein, when being executed, the computer readable program causes a computer to implement a speech detection method, the method comprising:
switching a speech acquisition system from a non-trigger mode into a trigger mode according to a first preset condition, and in the meantime recording a trigger mode operating reference time starting from zero, and setting a non-trigger mode operating reference time to zero;
acquiring speech signals by using the speech acquisition system in the trigger mode to obtain first pulse-code modulation data;
extracting the first pulse-code modulation data during the trigger mode operating reference time according to a second preset condition; and
matching the first pulse-code modulation data during the trigger mode operating reference time with a speech model to obtain speech data.

12. The non-transitory computer readable memory of claim 11, wherein:
the first preset condition is determined based on the non-trigger mode operating reference time and second pulse-code modulation data during the non-trigger mode operating reference time; and
the second preset condition is determined based on the trigger mode operating reference time, the first pulse-code modulation data within a preset time, and the second pulse-code modulation data.

13. The non-transitory computer readable memory of claim 11, before switching the speech acquisition system from the non-trigger mode into the trigger mode, the method further comprises:
recording the non-trigger mode operating reference time starting from zero; and
acquiring speech signals by using the speech acquisition system in the non-trigger mode to obtain the second pulse-code modulation data.

14. The non-transitory computer readable memory of claim 11, the method further comprises:
after extracting the first pulse-code modulation data during the trigger mode operating reference time, performing a Fourier-transformation to the first pulse-code modulation data to calculate corresponding decibel values of the first pulse-code modulation data; and
after extracting the second pulse-code modulation data during the non-trigger mode operating reference time, performing a Fourier-transformation to the second pulse-code modulation data to calculate corresponding decibel values of the second pulse-code modulation data.

15. The non-transitory computer readable memory of claim 12, wherein the first preset condition includes:
a first sub-condition that the recorded non-trigger mode operating reference time is equal to or longer than a first threshold value; and
a second sub-condition that a difference between a decibel value of the most recently acquired second pulse-code modulation data and an average decibel value of the second pulse-code modulation data during the entire non-trigger mode operating reference time is equal to or longer than the first preset value;
wherein when the first sub-condition and the second sub-condition are both satisfied, the first preset condition is satisfied.

16. The non-transitory computer readable memory of claim 15, wherein:
the first threshold value is a minimum speech abrupt detection time; and
the first preset value is in a range from 8 dB to 12 dB.

17. The non-transitory computer readable memory of claim 12, wherein the second preset condition includes:
a third sub-condition that the trigger mode operating reference time is equal to or longer than the second threshold value;
a fourth sub-condition that the trigger mode operating reference time is less than a third threshold value; and
a fifth sub-condition that a difference between an average decibel value of the first pulse-code modulation data within a preset time and an average decibel value of the second pulse-code modulation data in the non-trigger mode is less than a second preset value;
wherein when the third sub-condition, the fourth sub-condition, and the fifth sub-condition are all satisfied, the second preset condition is satisfied.

18. The non-transitory computer readable memory of claim 17, wherein:
the second threshold value is an effective speech input start analysis time;
the third threshold value is an effective speech input analysis time-out time;
the preset time is in a range from 1 seconds to 5 seconds; and
the second preset value is around from 1 dB to 3 dB.

19. The non-transitory computer readable memory of claim 17, further comprising:
in response to determining that the trigger mode operating reference time is longer than the third threshold value, switching the speech acquisition system from the trigger mode into the non-trigger mode, and recording the non-trigger mode operating reference time starting from zero, and set the trigger mode operating reference time to zero.

20. The non-transitory computer readable memory of claim 11, the method further comprises:
in response to determining that the first pulse-code modulation data during the trigger mode operating reference time has been extracted, switching the speech acquisition system from the trigger mode into the non-trigger mode, and recording the non-trigger mode operating reference time starting from zero, and set the trigger mode operating reference time to zero.
